(19) United States
(12) Patent Application Publication
(10) Pub. No.: US 2006/0208943 A1
(43) Pub. Date: Sep. 21, 2006

(54) Location tagging using post-processing

(75) Inventor: Steven A. Gronemeyer, Cedar Rapids, IA (US)

Correspondence Address: MACPHERSON KWOK CHEN & HEID LLP, 1762 TECHNOLOGY DRIVE, SUITE 226, SAN JOSE, CA, 95110, US

(73) Assignee: SiRF Technology, Inc.

(21) Appl. No.: 11/084,974

(22) Filed: Mar. 21, 2005

(51) Int. Cl. G01S 5/14

(52) U.S. Cl. 342/357.12

(57) ABSTRACT

A system is provided for storing positional data received from GPS signals in response to an event, and then processing that positional data at a later time to obtain detailed location information of the system at the time of the event. The received GPS signals may be decimated to a desired sampling rate and then stored for later correlation. In one embodiment, the system is a digital camera having an antenna, an RF front end, and a non-volatile memory device. The event which triggers the storage of the positional data is a photo capture by the digital camera. The positional data, in decimated but uncorrelated form, is stored with the image data in the non-volatile memory device. The positional data can then be transferred with the image data to a separate device, such as a personal computer, for post-processing.

### BACKGROUND OF THE INVENTION

Satellite-based positioning systems include constellations of earth orbiting satellites that constantly transmit orbit information and ranging signals to receivers. An example of a satellite-based positioning system is the Global Positioning System (GPS), which includes a constellation of earth orbiting satellites, also referred to as GPS satellites, satellite vehicles, or space vehicles. The GPS satellites circle the earth twice a day in a very precise orbit and transmit signal information to the earth. The satellite signal information is received by GPS receivers which can be in portable or mobile units, or in fixed positions on base stations and/or servers.

The GPS receiver uses the satellite signal information to calculate the receiver's precise location. Generally the GPS receiver compares the time GPS signals or satellite signals were transmitted by a satellite with the time of receipt of that signal at the receiver. This time difference between satellite signal reception and transmission provides the receiver with information as to the range of the receiver from the transmitting satellite. Using pseudo-range measurements (pseudo because the range information is offset by an amount proportional to the offset between GPS satellite clock and receiver clock) from a number of additional satellites, the receiver can determine its position. The GPS receiver uses received signals from three or four satellites to calculate the location of the receiver.

As GPS technology becomes more economical and compact it is becoming ever more common in consumer applications. For example, GPS systems are used for navigation in general aviation and commercial aircraft as well as by professional and recreational boaters. Other popular consumer uses of GPS include use in automobile navigation systems, construction equipment, and farm machinery as well as use by hikers, mountain bikers, and skiers, to name a few. Further, many location-based services are now available, such as asset tracking, turn-by-turn routing, and friend finding. Because GPS technology has so many consumer applications, it is finding increased popularity as an additional application hosted by a variety of portable electronic devices like personal digital assistants (PDAs), cellular telephones, and personal computers (PCs), to name a few.

A GPS receiver, when determining position information, typically relies on information from the satellite signal, including a pseudorandom code along with ephemeris and almanac data. The pseudorandom code is a code that identifies the satellite that is transmitting the corresponding signal and also helps the receiver to make ranging measurements. The almanac data tells the GPS receiver where each GPS satellite of the constellation should be at any time over a wide time interval that spans a few days or weeks. The ephemeris data does the same thing but much more accurately though over a much shorter time interval.

The broadcast ephemeris data, which is continuously transmitted by each satellite, contains important information about the orbit of the satellite, and time of validity of this orbit information. In particular, the broadcast ephemeris data of a GPS satellite predicts the satellite's state over a future interval of approximately four hours. The state prediction includes predictions of satellite position, velocity, clock bias, and clock drift. More particularly, the broadcast ephemeris data describe a Keplerian element ellipse with additional corrections that then allow the satellite's position to be calculated in an Earth-centered, Earth-fixed (ECEF) set of rectangular coordinates at any time during the period of validity of the broadcast ephemeris data. Typically, the broadcast ephemeris data is essential for determining a position.

Considering that the broadcast ephemeris data is only valid for a four hour interval and is normally essential for position determination, a GPS receiver is generally required to collect new broadcast ephemeris data at such time as the receiver needs to compute the satellite state when the validity time for the previously-collected broadcast ephemeris data has expired. The new broadcast ephemeris data can be collected either as direct broadcast from a GPS satellite or re-transmitted from a server. However, there are situations under which it is not possible to collect new broadcast ephemeris data from GPS satellites or from a server. As an example of situations in which new broadcast ephemeris data cannot be collected, a low signal strength of the satellite signals can prevent decoding/demodulating of the ephemeris data from the received satellite signal, the client can be out of coverage range of the server, and/or the server can be unavailable for a number of reasons, to name a few. When new broadcast ephemeris data is not available, the GPS receiver is typically unable to provide position information.

Furthermore, even when the GPS receiver is in a position from which it can receive the broadcast ephemeris information from a GPS satellite and/or server and properly decode the signal, the process of receiving and decoding adds substantially to the processing time. This additional processing time directly increases the time-to-first-fix (TTFF) while also increasing the power usage of the receiver. Both an increase in the TTFF and the power usage can be unacceptable to a user depending on the use being made of the receiver and power capabilities of the receiver (for example, a GPS receiver hosted on a client device like a cellular telephone would have stricter power use constraints). As a result of the increased use of GPS in portable consumer devices, and the increased reliance on the information provided by such devices, it is desirable to reduce the number of situations in which the GPS receiver cannot provide position information and/or cannot provide position in a time and power efficient manner.

FIG. 1 is a block diagram of a conventional GPS receiver 100. An antenna 102 is connected to an RF front end 110. The RF front-end 110 includes a low noise amplifier 114, a downconverter 116, an A/D converter 118, and an Automatic Gain Control (AGC) circuit 120. A reference oscillator 122 passes a signal to a frequency synthesizer 124 for use by the downconverter 116. The RF front-end 110 provides conditioning of the signal received by the antenna 102, including amplification, filtering, frequency down conversion, and sampling. The RF front-end 110 then passes the sampled IF signal to a correlator 130, which performs the high-speed digital correlation operations on the ranging code, and accumulation of these results over a range-code period. These accumulations are then passed to microprocessor 140, which controls the tracking loops and decodes and processes the navigation data stream to determine position, velocity, and the receiver's clock offset from GPS time. This information can then be used by an application 150, which is accessed by a user through user interface 152.

The search for a GPS C/A-code signal is conventionally performed using FFT techniques. During a signal search, a receiver typically searches a wide band of frequencies to find the satellite's Doppler-shifted signal frequency and a wide range of receiver-generated code phases to match the phase of the incoming signal. Although these FFT techniques are generally very effective at accomplishing massive parallel correlations, they require a significant amount of hardware and/or software to implement, and consume a considerable amount of time and power during operation.

In some situations, it would be desirable to provide some position-determining functionality, without the equipment cost and processing delays normally associated with full GPS receivers. This may be particularly desirable when the position-determining functionality is incorporated into a portable, low-power device.

### SUMMARY

A system is provided for storing positional data received from GPS signals in response to an event, and then processing that positional data at a later time to obtain detailed location information of the system at the time of the event. The received GPS signals may be decimated to a desired sampling rate and then stored for later correlation.

In one embodiment, the system comprises a digital camera having an antenna, an RF front end, and a non-volatile memory device. Digital cameras are typically provided with a very large amount of non-volatile memory, such as, e.g., a flash memory card or a hard disk drive. The event which triggers the storage of the positional data is a photo capture by the digital camera. The positional data, in decimated but uncorrelated form, is stored with the image data in the non-volatile memory device. The positional data can then be transferred with the image data to a separate device, such as a personal computer, for post-processing.

Substantially all of the conventional GPS digital signal processing is performed by the separate device. This processing may include but is not limited to carrier recovery, PRN code locking, pseudo range extraction, ephemeris data extraction, almanac collection, satellite selection, navigation solution calculation, and differential corrections. In some embodiments, the ephemeris and/or almanac data corresponding to the stored positional data is retrieved from elsewhere, such as a server on the Internet, rather than from the satellite signal. This processing by the post-processing system provides the latitudinal and longitudinal location of the camera at the time the image was captured.

In accordance with embodiments of the present invention, a method of processing a satellite positioning signal is provided, comprising: receiving a satellite positioning signal using a host system; upon occurrence of a predetermined event, storing data corresponding to the satellite positioning signal in uncorrelated form in a non-volatile memory of the host system; and transferring the uncorrelated data from the portable device to a post-processing system.

In accordance with embodiments of the present invention, a system for capturing global positioning system (GPS) information associated with an event is provided. The system includes a host system, comprising: a nonvolatile memory; and a GPS subsystem, comprising: an antenna for receiving radio frequency (RF) signals from a plurality of GPS satellites; an RF processing module for generating uncorrelated data corresponding to an RF signal received by the antenna; and control logic coupled to the RF processing module for causing the RF processing module to store to the uncorrelated data in the nonvolatile memory in response to detecting a predetermined stimulus.

In accordance with embodiments of the present invention, a system for satellite position information is provided, comprising: a host system comprising a radio frequency (RF) signal processing subsystem. The RF signal processing subsystem comprises: a means for processing an RF signal received by an antenna, said processing means generating uncorrelated data corresponding to the RF signal received by the antenna; and a control means coupled to the processing means for causing the processing means to store to the uncorrelated data in the nonvolatile memory in response to detecting a predetermined stimulus.

This invention will be more fully understood in conjunction with the drawings and following detailed description.

### DESCRIPTION OF THE DRAWINGS

FIG. 1 is a block diagram of a conventional GPS receiver.

FIG. 2 is a flow chart of a positioning signal processing method, in accordance with embodiments of the present invention.

FIG. 3 is a block diagram of a system for location tagging using post-processing, in accordance with embodiments of the present invention.

FIG. 4 shows a system for retrieving ephemeris and/or almanac data over a wide-area network, in accordance with embodiments of the present invention.

### DETAILED DESCRIPTION

The following description is meant to be illustrative only and not limiting. Other embodiments of this invention will be obvious from this description to those skilled in the art.

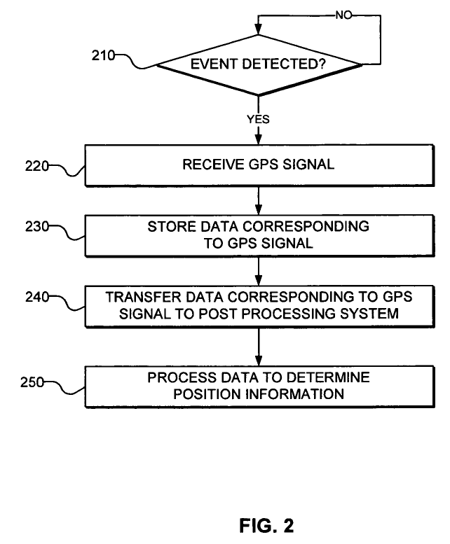

In accordance with various embodiments, systems and methods are provided for location tagging using post-processing of a satellite positioning signal. FIG. 2 is a flow chart of a positioning signal processing method, in accordance with embodiments of the present invention. In step 210, a system detects the occurrence of a predetermined event. In step 220, the system receives a signal corresponding to the signals detected from a plurality of positioning satellite vehicles, such as GPS satellites. In step 230, the host system stores data corresponding to the received GPS signal. In step 240, the data corresponding to the received GPS signal is transferred to a post-processing system. Finally, in step 250, the data corresponding to the received GPS signal is processed to obtain information regarding a position of the signal receiving device at the time of the event.

In accordance with embodiments of the present invention, GPS technology may be used to embed a GPS sample capture into a host device that already has storage capacity and has a need to associate a position with an event or some other data, but does not need to do so in real time. In one embodiment, the host device comprises a digital camera, where a sample of the GPS signal would be stored with each picture taken. Given the resolution of contemporary cameras, the data for the GPS signal is a small fraction of the image data stored, but this may vary by application or with the evolution of flash technology. In some embodiments, the amount of GPS data stored may be adjusted on a picture by picture basis.

Sometime after the initial image and GPS data capture, the GPS and picture data is downloaded to a post-processing system. In the post-processing system, the GPS data is combined with ephemeris and/or almanac data to determine the position and time for each picture. The ephemeris and almanac data may be acquired, for example, from another system over a wide area network (WAN), such as the Internet, instead of from the GPS signal. In some cases, the time could come from the host device rather than from the GPS signal. For example, the camera may include a clock with the correct time that is stored with the GPS data and is used by the post-processing system to determine the location of the camera at the time the picture was taken.

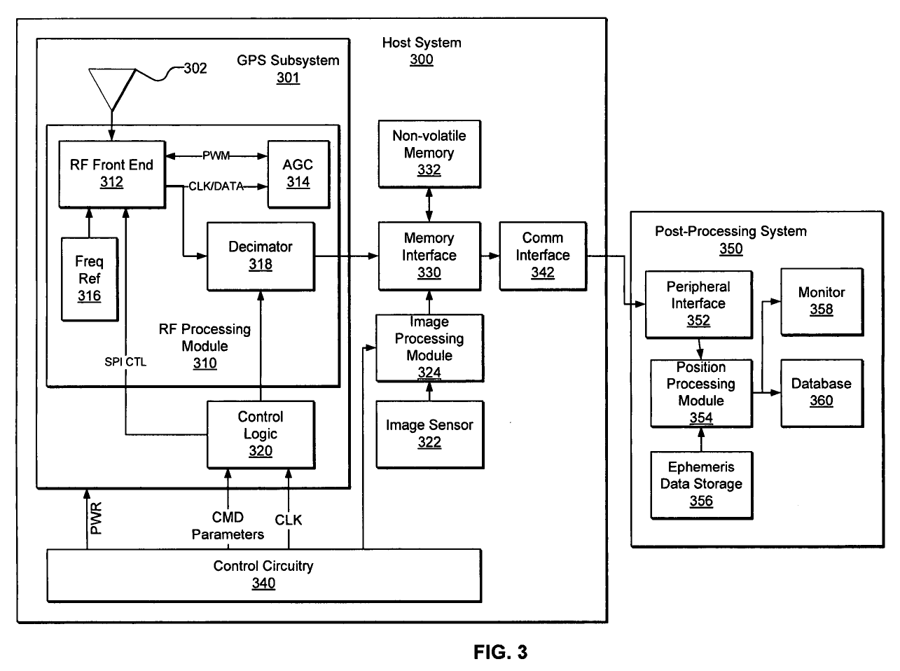

FIG. 3 shows an embodiment in which the host system comprises a digital camera 300. The camera 300 includes a GPS subsystem 301. The GPS subsystem 301 comprises an antenna 302, an RF processing module 310, and control logic 320. The host system 300 is couplable to a post-processing system 350.

Various types of digital camera systems may be used. Typically, a digital camera includes a lens that focuses an image onto a solid-state image sensor, such as a charge coupled device (CCD) or a complementary metal oxide semiconductor (CMOS) sensor. An image processing module processes the signal from the image sensor into a digital signal that can then be stored on the nonvolatile storage device. The image processing module converts the analog signal to a digital signal, and may compress that data to reduce the size of the image data file A frame buffer may be provided for temporarily storing the image data before the data is written to the nonvolatile storage device. The embodiment shown in FIG. 3 includes an image sensor 322, an image processing module 324, a memory interface 330, and a nonvolatile memory 332. The nonvolatile memory 332 may comprise, e.g., a removable flash memory storage device, and the memory interface 330 comprises a flash controller. It will be understood that other components and designs may be used in other embodiments.

In the embodiment shown in FIG. 3, the RF processing module 310 comprises an RF front-end 312, which is used to amplify the very weak (−130 dBm nominal) GPS signal, filter it, and down-convert it to an Intermediate Frequency (IF) of, e.g., 4.092 MHz, for digital processing. In some embodiments, the RF front-end outputs a baseband spread-spectrum signal, instead of the IF signal. A decimator 318 may be provided for reducing the sample rate of the signal output stream of the RF subsystem 301.

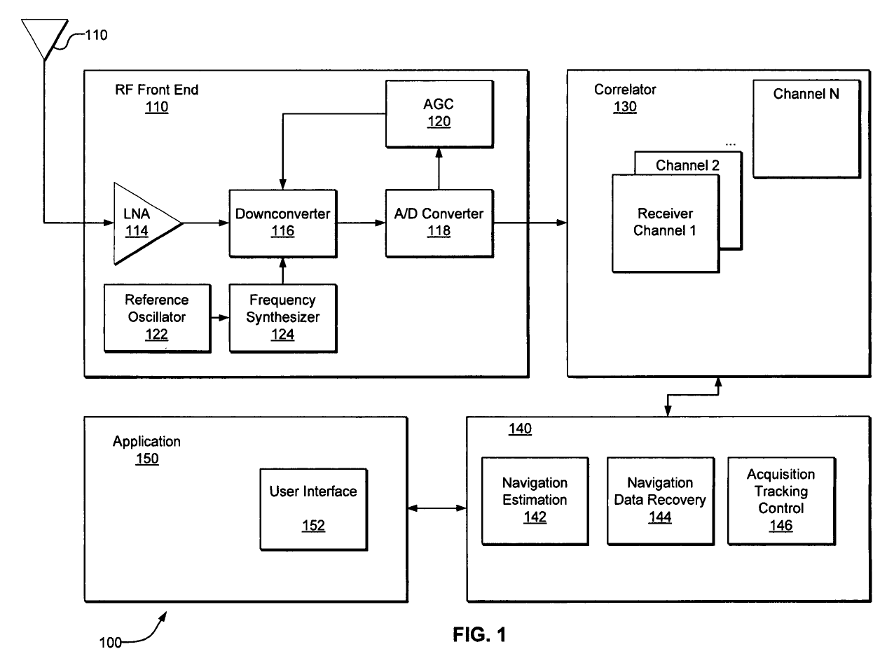

In conventional GPS systems, as shown in FIG. 1, a correlation function would be performed on the signal output from the RF front-end. In contrast, in FIG. 3, the signal output from the RF processing module 310 is stored in uncorrelated form in the nonvolatile memory 332. In one embodiment, the GPS signal is sampled at 16.369 MHz and decimated to a nominal two samples per chip, or 2.046 mega samples per second, where each sample is quantized to two bits, a sign and a magnitude bit.

In accordance with embodiments of the present invention, the GPS signals are received and stored in response to a triggering event. In the embodiment shown in FIG. 3, the triggering event is taking of a photograph. The triggering event may be the depression of a shutter release button by a user, or may be a trigger which is set to occur on a periodic, scheduled basis. In other embodiments, any type of stimulus may be used for initiating the storage of the GPS data.

The host system 300 may control the GPS subsystem 301 in a variety of ways. For example, the host system 300 may include control circuitry 340 for controlling when to power and enable the GPS subsystem 301. When enabled, the host control circuitry 340 generates events at which the GPS sample process is triggered. In some embodiments, the host control circuitry 340 also provides to the GPS subsystem 301 parameters that determine how long the sample should be taken, where the sample should be stored, and a label to be stored with the samples (such as the time or other labeling). Thus, in order to conserve power, the host control circuitry 340 may be used to turn off the RF front end 312 at all times except for the relatively small period of time during which samples are being received. The host control circuitry 340 may also enable the memory interface 330 to accept data from the GPS subsystem 301 rather than other sources.

When samples are being generated, the GPS subsystem 301 operates much like a conventional GPS system. The RFIC forming the RF front-end 312 may be programmed by a control sequencer to its defined frequency. Alternatively, the host control circuitry 340 could manage this action independently. In some embodiments, a Serial Peripheral Interface (SPI) may be provided to enable the control logic 322 to control the RF front-end 312.

The AGC circuit 314 could operate either through the SPI, or, in other embodiments, it may be preferred to use the alternative method of a pulse width modulation (PWM) interface. In yet other embodiments, the functionality of the AGC circuit 314 may be incorporated into the RF front end 312. The host control circuitry 340 may also provide a clock signal to the RF processing module 310, so that communication is possible in low power modes where the RFIC and its clock are powered off.

The amount of GPS data stored for each event may vary, depending on the application and the capabilities of the host system 300. In one embodiment, the GPS signal is decimated directly to 2 samples per chip. If 80 ms of GPS data is stored for each event, then each event will result in 20 KB of GPS data being stored in the nonvolatile memory 332. In some embodiments, if the nonvolatile memory 332 has a storage rate slower than the output rate of the GPS subsystem 301, a buffer may be provided for temporarily storing the GPS data.

The GPS signal data stored in the nonvolatile memory 332 may be transferred to the post-processing system 350 in a variety of ways. In some embodiments, the nonvolatile memory 332 comprises a removable flash storage device, such as, e.g., a CompactFlash or MultiMedia card. This flash storage device may be removed from the host system 300 and inserted into a corresponding flash reader device on the post-processing system 350. In other embodiments, the host system 300 includes an interface 342 for transferring the data to the post-processing system 350. The interface 342 may comprise, for example, a Universal Serial Bus (USB) port on a camera, which may be coupled to a corresponding USB port on a personal computer, which forms the post-processing system 350. In other embodiments, the interface 342 may comprise other types of communication interfaces, both wired or wireless, such as, e.g., Bluetooth or IEEE 802.11X.

The post-processing system 350 may include an off-line host application, such as software for controlling the digital camera 300 and the downloading of photographs from the camera 300. In addition, the post-processing system 350 includes a position processing module 354 for processing the GPS data from the nonvolatile memory 332. The position processing module 354 may comprise a dynamic linked library (DLL) module.

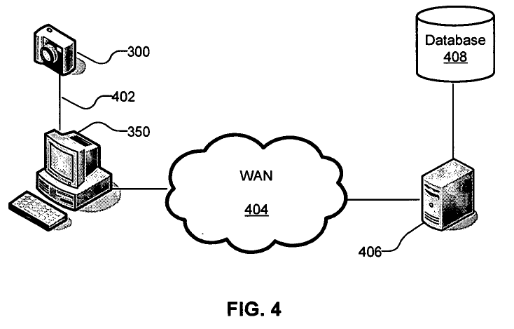

The position processing module 354 may include the functionality to retrieve ephemeris and/or almanac data for the appropriate time period from an external source, such as a server on the Internet. FIG. 4 shows an exemplary system 400 in which the host system 300 (e.g., a digital camera) is coupled to the post-processing system 350 (e.g., a personal computer) via, e.g., a USB cable 402. The post-processing system 350 in turn is coupled via a wide area network 404 (e.g. the Internet) to a server 406. The post-processing system 350 requests the ephemeris and/or almanac data from the server 406, which then retrieves the requested data from a database 408.

In other embodiments, the position processing module 354 may retrieve the ephemeris and/or almanac data from the GPS data. However, by retrieving the ephemeris and/or almanac data from an external source, the GPS subsystem 301 need not store as much GPS data in order to determine location. For example, in order to extract the ephemeris data from the captured GPS data, at least 18 seconds of sample time would be stored. At two samples per chip and 4 bits per complex-valued sample, the GPS data for a single event could consume over 18 Mbytes of storage on the non-volatile memory 332.

The position processing module 354 may also include the functionality to process the captured GPS samples with the ephemeris and/or almanac data and any other data from the host system 300, such as capture time, and compute an accurate position and time from this data. The resulting solution may then be associated with the event data (e.g., photo data) as additional labeling information.

The correspondence between the location information and the digital photograph can be utilized in a variety of applications. In some embodiments, the location information produced by the position processing module 354 may be stored in a database 360 managed by the position processing module 354 or another application. The database 360 provides the enhanced capability of searching for event data by time and position, as well as any other attributes the host system 300 normally provides. In the digital camera application, for example, a user may query the database 360 for all photos that were taken within 5 miles of a certain address and within three hours of a certain date and time. These photos could be shared or aggregated with other databases for wider searches with common attributes.

The database 360 may also be used in conjunction with map images. For example, a user may select a point on a map displayed on the monitor 358. Then, all the photographs which were taken within a prescribed distance of that point may be displayed. In other embodiments, a map may display an indicator, such as a colored dot or icon, at each point on a map where an event occurred (e.g., a photograph was taken).

In the embodiments described above, a GPS subsystem is provided as part of a platform for storing GPS data in response to some stimulus (e.g., a camera shutter press, a periodic schedule, etc.). This system may be particularly advantageous when the location information is not needed in real time and must be taken at very low power. This system may be especially desirable when the underlying host system is already provided with a large amount of memory. Thus, one suitable application is a digital camera, which typically includes a large flash memory card, is small and portable, and operates on battery power. This can enable a user to store a plurality of images and a plurality of corresponding unprocessed GPS data samples for extended periods of time, and then download them all in a single batch for processing by the post-processing system.

In addition, users of digital cameras are typically accustomed to processing the image data from the digital camera on a separate system, e.g., a personal computer. These users are also accustomed to utilizing an application on the personal computer for downloading, managing, and storing this image data. Thus, the additional GPS processing performed by the post-processing system on the GPS data would not result in a significant additional burden on the user and would not require additional communication interfaces for the host system.

In many cases, the personal computer forming the post-processing system 350 is already provided with a broadband Internet connection for other purposes. Thus, the retrieval of the ephemeris and/or almanac data from another server on the Internet can make the signal processing more efficient, while not imposing a significant additional burden on the user and the user's hardware systems.

The above description of illustrated embodiments of positioning signal processing systems is not intended to be exhaustive or to limit the system to the precise form disclosed. The teachings of the systems provided herein can be applied to other processing systems and communication systems, not only for the systems described above. While specific embodiments of, and examples for, the GPS signal processing are described herein for illustrative purposes, various equivalent modifications are possible within the scope of the system, as those skilled in the relevant art will recognize. For example, the host system which incorporates the GPS subsystem need not be a digital camera. Embodiments of the present invention may be implemented as any system which stores uncorrelated GPS signal data in response to some event or stimulus.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

The figures provided are merely representational and are intended to illustrate various implementations of the invention that can be understood and appropriately carried out by those of ordinary skill in the art.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of processing a satellite positioning signal, comprising:
receiving a satellite positioning signal using a host system;
upon occurrence of a predetermined event, storing data corresponding to the satellite positioning signal in uncorrelated form in a non-volatile memory of the host system; and
transferring the uncorrelated data from the host system to a post-processing system.

2. The method of claim 1, further comprising:
using the post-processing system to correlate the satellite positioning signal.

3. The method of claim 1, wherein:
the host system comprises an image capture module for capturing an image; and
the predetermined event comprises an image capture by the host system.

4. The method of claim 3, further comprising:
processing the uncorrelated satellite positioning signal using the post-processing system to determine a location of the host system during the predetermined event; and
displaying the captured image while providing information regarding the determined location.

5. The method of claim 4, wherein:
said displaying the captured image comprises displaying the captured image with a map indicating the determined location.

6. The method of claim 1, further comprising:
retrieving ephemeris data using the post-processing system.

7. The method of claim 6, wherein:
said retrieving ephemeris data using the post-processing system comprises retrieving ephemeris data from a server over a wide-area network.

8. The method of claim 1, further comprising:
decimating the uncorrelated satellite positioning signal prior to storage in the non-volatile memory.

9. The method of claim 1, wherein:
the host system is battery-powered.

10. A system for capturing global positioning system (GPS) information associated with an event, comprising:
a host system, comprising:
a nonvolatile memory; and
a GPS subsystem, comprising:
an antenna for receiving radio frequency (RF) signals from a plurality of GPS satellites;
an RF processing module for generating uncorrelated data corresponding to an RF signal received by the antenna; and
control logic coupled to the RF processing module for causing the RF processing module to store to the uncorrelated data in the nonvolatile memory in response to detecting a predetermined stimulus.

11. The system of claim 10, wherein:
the RF processing module is configured to generate decimated data corresponding to the RF signal received by the antenna.

12. The system of claim 10, further comprising:
a post-processing system comprising:
an interface for receiving the uncorrelated data from the nonvolatile memory in the host system; and
a processing module for processing the uncorrelated data to determine a location of the host system at the time of the predetermined stimulus.

13. The system of claim 12, wherein:
the processing module is configured to retrieve ephemeris data corresponding to the uncorrelated data to determine the location of the host system at the time of the predetermined stimulus.

14. The method of claim 13, wherein:
said retrieving ephemeris data using the processing module comprises retrieving ephemeris data from a server over a wide-area network.

15. The system of claim 10, wherein:
the host system further comprises an image capture module for capturing an image; and
the predetermined stimulus corresponds to an image capture.

16. The method of claim 15, further comprising:
processing the uncorrelated satellite positioning signal using the post-processing system to determine a location of the host system during the predetermined stimulus; and
displaying the captured image while providing information regarding the determined location.

17. The method of claim 16, wherein:
said displaying the captured image comprises displaying the captured image with a map indicating the determined location.

18. A system for processing satellite position information, comprising:
a host system comprising a radio frequency (RF) signal processing subsystem, wherein the RF signal processing subsystem comprises:
a means for processing an RF signal received by an antenna, said processing means generating uncorrelated data corresponding to the RF signal received by the antenna; and
control means coupled to the processing means for causing the processing means to store to the uncorrelated data in the nonvolatile memory in response to detecting a predetermined stimulus.

19. The system of claim 18, wherein:
the processing means is configured to generate decimated data corresponding to the RF signal.

20. The system of claim 18, further comprising:
a post-processing system comprising:
an interface for receiving the uncorrelated data from the nonvolatile memory in the host system; and
a processing module for processing the uncorrelated data to determine a location of the host system at the time of the predetermined stimulus.

21. The system of claim 20, wherein:
the processing module is configured to retrieve ephemeris data corresponding to the uncorrelated data to determine the location of the host system at the time of the predetermined stimulus.

22. The system of claim 18, wherein:
the host system further comprises an image capture module for capturing an image; and
the predetermined stimulus corresponds to an image capture.
